(19) United States
(12) Patent Application Publication
(10) Pub. No.: US 2004/0128213 A1
(43) Pub. Date: Jul. 1, 2004

(54) Material requirement planning system and method for re-scheduling purchase orders of materials

(76) Inventor: Hung-Shan Wei, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/404,335

(22) Filed: Mar. 31, 2003

(30) Foreign Application Priority Data
Dec. 25, 2002 (TW) 91137232

(51) Int. Cl. G06F 17/60

(52) U.S. Cl. 705/28

(57) ABSTRACT

A material requirement planning system (100) for re-scheduling purchase orders of materials includes: a database (5) for storing data needed for material requirement planning; a data retrieving unit (110) for retrieving data on materials from the database; a calculating unit (120) for calculating inventories, net requirements and gross requirements of materials; a data assessing unit (130) for determining data ranges and attributes based on data retrieved by the data retrieving unit and on results generated by the calculating unit; a routing re-scheduling unit (140) for re-scheduling demand routing of materials; and a purchase order generating unit (150) for generating purchase orders of materials. The calculating unit includes an inventory calculating sub-unit (121) for calculating inventories of materials, and a requirement calculating sub-unit (122) for calculating net requirements and gross requirements of materials. A related method is also disclosed.

### BACKGROUND OF THE INVENTION

1. Field of the Invention

The present invention relates to material requirement planning systems and methods, and particularly to a system and method for re-scheduling purchase orders of materials.

2. Background of the Invention

Master production schedules (MPSs) are vital for all manufacturers, especially large-scale manufacturing enterprises. An MPS is a production schedule for finished products spanning a period of time in the future. The aim of the MPS is to timely forward the finished products to relevant customers, while avoiding overloading or underutilization of production apparatus and production capacity. Usually, a manufacturer makes purchase orders according to production demand, buffer inventory and lead time, and transmits the purchase orders to corresponding vendors to obtain the necessary raw materials and components. The vendors provide the raw materials and components to the manufacturer according to the purchase orders. Changes in market supply and demand cause much uncertainty in production demand, and purchase orders frequently need to be changed or re-scheduled. If the purchase orders are not re-scheduled methodically and timely, this can lead to delays in supply of the raw materials and components, and consequent delays in production.

China Patent No. CN1277401A, published on Dec. 20, 2000, discloses a purchase order producing system. The system is executed on a computer that comprises a storage and a processor. The system comprises: a demand database for recording demand for material in each week in a predetermined period; a buffer inventory module for calculating an average demand in each week, and for calculating a buffer inventory that should be maintained at the end of each week based on the average demand; and a purchase order module for generating purchase orders for each week based on the average demand of the week, on-hand inventory and the buffer inventory.

The above-mentioned purchase order producing system can meet demand for material only to a limited extent; that is, according to weekly cycles. The system cannot generate purchase orders according to more up-to-date production demand and material demand. Nowadays, production demand can fluctuate even daily, in order for the manufacturer to be able to quickly respond to a customer's new requirements. If material demand cannot be changed quickly to support a new production demand, the manufacturer runs the risk of late or inefficient production, having an unsatisfied customer, or even losing a customer.

Thus, a material requirement planning system and method is needed for determining material demand each day based on production and inventories, and for generating corresponding purchase orders.

### SUMMARY OF THE INVENTION

Accordingly, an object of the present invention is to provide a material requirement planning system and method for timely re-scheduling purchase orders of materials.

Another object of the present invention is to provide a material requirement planning system and method for timely calculating net requirements of materials and gross requirements thereof.

A further object of the present invention is to provide a material requirement planning system and method for timely re-scheduling demand routing of materials based on available inventories thereof and manufacturing orders.

In order to accomplish the above-mentioned objects, the present invention provides a material requirement planning system and method for re-scheduling purchase orders of materials. A preferred embodiment of the material requirement planning system comprises: a database for storing data needed for material requirement planning; a data retrieving unit for retrieving data on materials from the database; a calculating unit for calculating inventories, net requirements and gross requirements of materials; a data assessing unit for determining data ranges and attributes based on data retrieved by the data retrieving unit and on results generated by the calculating unit; a routing re-scheduling unit for re-scheduling demand routing of materials; and a purchase order generating unit for generating purchase orders of materials. The calculating unit comprises an inventory calculating sub-unit for calculating inventories of materials, and a requirement calculating sub-unit for calculating net requirements and gross requirements of materials.

In another aspect of the present invention, a material requirement planning method for re-scheduling purchase orders of materials comprises the following steps for each material: (i) receiving data on the material from a database; (ii) calculating inventory of the material, the calculated inventory comprising on-hand inventory and available inventory of the material; (iii) determining whether the available inventory of the material is zero; (iv) determining whether the available inventory comes from one or more allocated inventories if the available inventory is not zero, or proceeding directly to step (vi) if the available inventory is zero; (v) determining whether the material needs re-scheduling of demand routing if the available inventory does not come from said allocated inventories; (vi) calculating one or more net requirements of the material; and (vii) generating one or more purchase orders of the material based on said net requirements of the material, and calculating one or more gross requirements of the material.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of an application environment of a material requirement planning system for re-scheduling purchase orders of materials in accordance with the present invention, wherein said system comprises a database;

FIG. 2 is a schematic diagram of information flow involving a material requirement planning system for re-scheduling purchase orders of materials in accordance with a preferred embodiment of the present invention;

FIG. 3 is a schematic diagram of software infrastructure of the material requirement planning system of FIG. 2, and showing connectivity of said system with the database and associated information; and

FIGS. 4A and 4B in combination comprise a flow chart of re-scheduling purchase orders of materials in accordance with the present invention.

### DETAILED DESCRIPTION OF PREFERRED EMBODIMENTS OF THE INVENTION

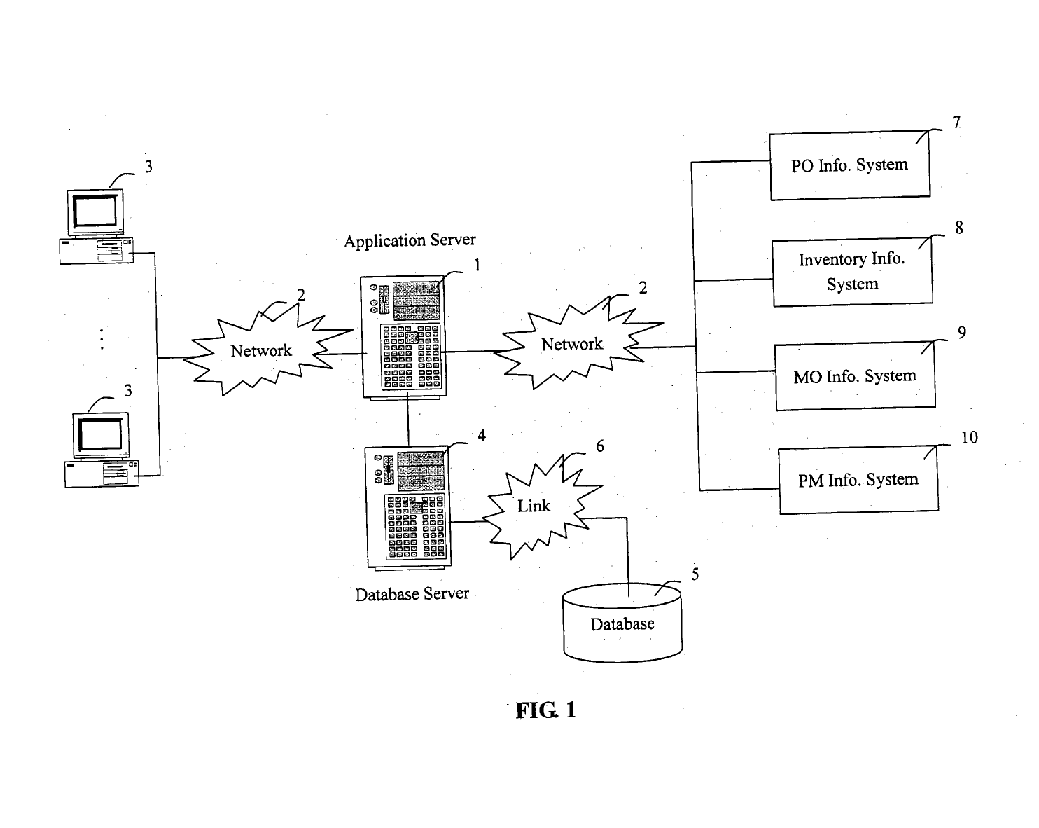

FIG. 1 is a schematic diagram of an application environment of a material requirement planning system for re-scheduling purchase orders of materials in accordance with the present invention. The material requirement planning system employs a three-tier infrastructure: a plurality of client computers 3, an application server 1, and a database server 4, all of which are linked via a network 2. The application server 1 is linked to a purchase order (PO) information system 7, an inventory information system 8, a manufacturing order (MO) information system 9, and a production management (PM) information system 10 via the network 2. The above-mentioned information systems store corresponding purchase orders, inventory information, manufacturing orders, and production information in a database 5 via the network 2 and the application server 1. The network 2 is an electronic communication network such as an intranet, the Internet or another suitable communication network.

The client computers 3 are distributed at different locations, and respectively provide interfaces for various users of the material requirement planning system. The users comprise relevant production managers. The users can access the application server 1 via the client computers 3 to perform operations such as maintaining data in the database server 4.

The application server 1 comprises core and mutable enterprise logic of the material requirement planning system. Such logic includes rules for execution and management of the material requirement planning system. The application server 1 processes input by users, and returns results of processing to users.

The database server 4 is connected to the database 5 by a link 6. The link 6 is a kind of database connectivity, such as open database connectivity (ODBC) or Java database connectivity (JDBC). The database server 4 controls processing of data stored in the database 5. Such processing includes reading, writing, deleting, modifying, and backup.

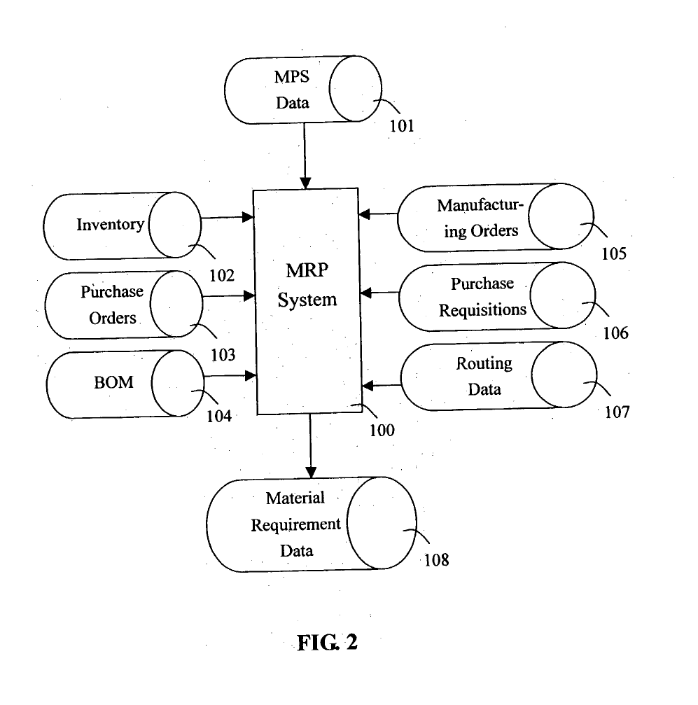

FIG. 2 is a schematic diagram of information flow involving a material requirement planning system 100 for re-scheduling purchase orders of materials in accordance with a preferred embodiment of the present invention. In the preferred embodiment, relevant information comprises inventory 102, purchase orders (POs) 103, bills of material (BOM) 104, manufacturing orders (MOs) 105, purchase requisitions (PRs) 106, and routing data 107. By integrating and processing the above-mentioned information and master production scheduling (MPS) data 101, the material requirement planning system 100 generates material requirement data 108 based on up-to-date production statuses and up-to-date available inventories of materials. The material requirement data 108 comprise net requirements, gross requirements, and re-scheduled purchase orders. The above-mentioned data are stored in the database 5.

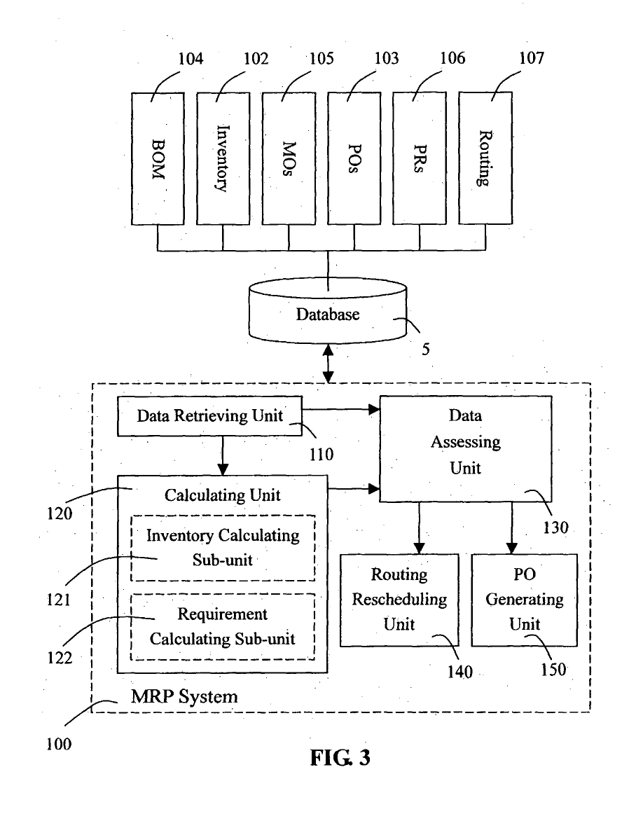

FIG. 3 is a schematic diagram of software infrastructure of the material requirement planning system 100, and showing connectivity of the material requirement planning system 100 with the database 5 and associated information. In the preferred embodiment of the present invention, the material requirement planning system 100 is located in the application server 1, and comprises a data retrieving unit 110, a calculating unit 120, a data assessing unit 130, a routing rescheduling unit 140 and a purchase order generating unit 150. The data retrieving unit 110 is used for retrieving from the database 5 data needed by the material requirement planning system 100. The retrieved data comprise the master production scheduling (MPS) 101, the inventory 102, the purchase orders (POs) 103, the bills of material (BOMs) 104, the manufacturing orders (MOs) 105, the purchase requisitions (PRs) 106, and the routing data 107. The calculating unit 120 is used for calculating inventories and requirements of materials based on the data retrieved by the data retrieving unit 110. The calculating unit 120 comprises an inventory calculating sub-unit 121 and a requirement calculating sub-unit 122, which are respectively for calculating inventories and requirements of materials. The requirements comprise net requirements and gross requirements. The data assessing unit 130 is used for making determinations on ranges of data and attributes of data, based on data retrieved by the data retrieving unit 110 and on results generated by the calculating unit 120. For example, the data assessing unit 130 determines whether inventories of materials are zero, or whether inventories of materials are adjusted from other allocated inventories. The routing rescheduling unit 140 is used for re-scheduling demand routing of materials based on results of the data assessing unit 130. The purchase order generating unit 150 is used for generating purchase orders of materials based on outstanding requirements after rescheduling of demand routing.

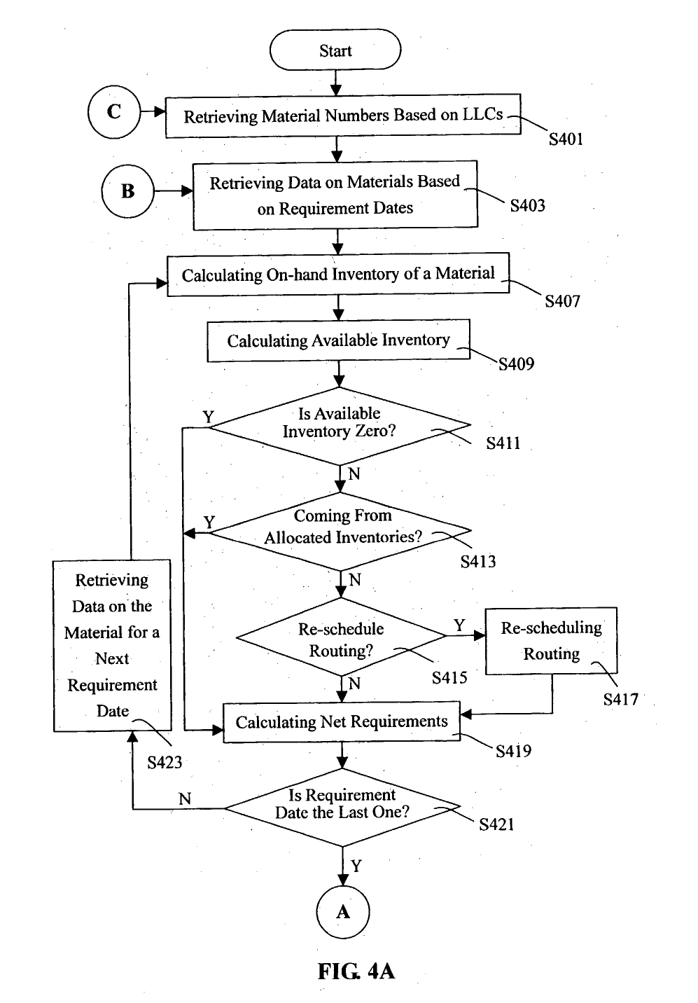

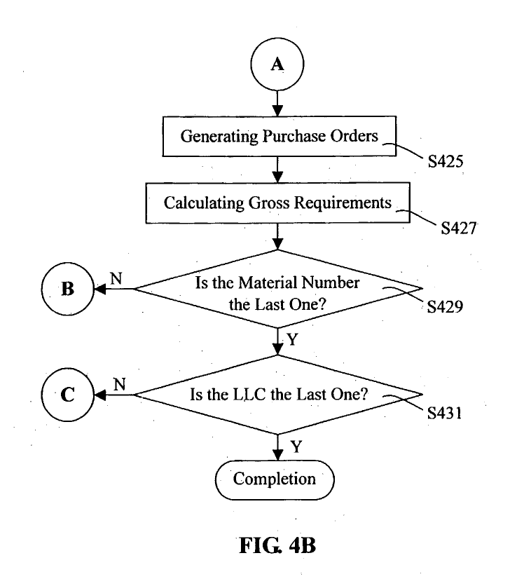

FIGS. 4A and 4B in combination comprise a flow chart of re-scheduling purchase orders of materials in accordance with the present invention. At step S401, the data retrieving unit 110 retrieves material numbers from the database 5 based on low-level codes (LLCs) of materials. At step S403, the data retrieving unit 110 retrieves data on materials corresponding to the material numbers, based on requirement dates of the materials. The retrieved data comprise inventories, purchase orders, and manufacturing orders. At step S407, the inventory calculating unit 121 calculates on-hand inventory of a material for a first requirement date. The on-hand inventory is up-to-date inventory that is in a production warehouse, and is calculated by the inventory calculating unit 121 in real time. At step S409, the inventory calculating unit 121 calculates an available inventory of the material. The available inventory is inventory that can be directly used in production. The available inventory is calculated as the on-hand inventory plus on-order inventory, minus allocated inventory, buffer inventory and inventory not able to be used because of unsatisfactory quality. At step S411, the data assessing unit 130 determines whether the available inventory of the material is zero. If the available inventory of the material is zero, the procedure proceeds directly to step S419 described below. If the available inventory is not zero, at step S413, the data assessing unit 130 determines whether the available inventory comes from allocated inventories or not. If the available inventory comes from allocated inventories, the procedure proceeds directly to step S419 described below. If the available inventory does not come from allocated inventories, at step S415, the data assessing unit 130 determines whether the material needs re-scheduling of demand routing, based on the manufacturing orders (MOs) 105 and the routing data 107. If the material does not need re-scheduling of demand routing, the procedure proceeds directly to step S419 described below. If the material needs re-scheduling of demand routing, at step S417, the routing rescheduling unit 140 re-schedules demand routing of the material based on the manufacturing orders (MOs) 105 and the routing data 107, whereupon the procedure proceeds to step S419. At step S419, the requirement calculating sub-unit 122 calculates net requirements for the material on the requirement date.

At step S421, the data assessing unit 130 determines whether the requirement date is a last requirement date for the material. If the requirement date is not a last requirement date, at step S423, the data retrieving unit 110 retrieves data on the material for a next requirement date, whereupon the procedure returns to step S407 for calculating net requirements of the material for the next requirement date. If and when the data assessing unit 130 determines that all net requirements of the material on all requirement dates have been obtained, the procedure proceeds to step S425 described below

At step S425, the purchase order generating unit 150 generates purchase orders for the material according to net requirements for each requirement date. At step S427, the requirement calculating sub-unit 122 calculates gross requirements of the material based on the net requirements thereof. At step S429, the data assessing unit 130 determines whether the retrieved material number is the last one of material numbers that have the same low-level code of the material. If the retrieved material number is not the last one, the procedure returns to step S403 for retrieving data on a material corresponding to a next material number. If the retrieved material number is the last one, at step S431, the data assessing unit 130 determines whether the low-level code of the material is the last one of low-level codes in the bill of material 104. If the low-level code of the material is not the last one, the procedure returns to step S401 for retrieving material numbers based on a next low-level code. If and when the low-level code of the material is the last one, this means that all the materials have been processed, and the procedure is completed.

While a preferred embodiment of the present invention has been described above, it should be understood that it has been presented by way of example only and not by way of limitation. Thus the breadth and scope of the present invention should not be limited by the above-described exemplary embodiment, but should be defined only in accordance with the following claims and their equivalents.

What is claimed is:

1. A material requirement planning system for re-scheduling purchase orders of materials, the system comprising:
a database for storing data needed for material requirement planning;
a data retrieving unit for retrieving data on materials from the database;
a calculating unit for calculating inventories, net requirements and gross requirements of materials; and
a data assessing unit for determining data ranges and attributes based on data retrieved by the data retrieving unit and on results generated by the calculating unit.

2. The material requirement planning system as claimed in claim 1, further comprising a routing re-scheduling unit for re-scheduling demand routing of materials based on results of the data assessing unit.

3. The material requirement planning system as claimed in claim 1, further comprising a purchase order generating unit for generating purchase orders of materials.

4. The material requirement planning system as claimed in claim 1, wherein the calculating unit comprises an inventory calculating sub-unit for calculating inventories of materials.

5. The material requirement planning system as claimed in claim 4, wherein the calculating unit further comprises a requirement calculating sub-unit for calculating net requirements and gross requirements of materials.

6. The material requirement planning system as claimed in claim 1, wherein the data on re-scheduling purchase orders of materials comprises inventory data, purchase orders, manufacturing orders, routing data, and bills of material.

7. A material requirement planning method for re-scheduling one or more purchase orders of one or more materials, the method comprising the steps of:
(a) retrieving data on a material from a database;
(b) calculating inventory of the material, the calculated inventory comprising on-hand inventory and available inventory of the material;
(c) determining whether the available inventory of the material is zero; (d) determining whether the available inventory comes from one or more allocated inventories if the available inventory is not zero, or proceeding directly to step (f) if the available inventory is zero;
(e) determining whether the material needs re-scheduling of demand routing if the available inventory does not come from said allocated inventories; and
(f) calculating one or more net requirements of the material.

8. The material requirement planning method as claimed in claim 7, wherein the data retrieved at step (a) comprises inventory data, one or more purchase orders, one or more manufacturing orders, routing data, and one or more bills of material.

9. The material requirement planning method as claimed in claim 7, wherein at step (a), retrieving data on the material is performed according to requirement dates of the material.

10. The material requirement planning method as claimed in claim 9, further comprising the steps of:
(g) determining whether the retrieved data on the material is data for a last requirement date; and
(h) retrieving data on the material for a next requirement date and returning to step (b), if said retrieved data on the material is not data for a last requirement date.

11. The material requirement planning method as claimed in claim 7, further comprising the step of:
generating one or more purchase orders of the material based on said net requirements of the material, and calculating one or more gross requirements of the material.

12. The material requirement planning method as claimed in claim 7, wherein step (a) comprises retrieving data on materials from the database, which is performed according to one or more material numbers of the materials.

13. The material requirement planning method as claimed in claim 12, further comprising the steps of:
determining whether a retrieved material number is a last material number; and
retrieving a next material number and returning to step (a), if said retrieved material number is not a last material number.

14. The material requirement planning method as claimed in claim 7, wherein step (a) comprises retrieving data on materials from the database, which is performed according to a low-level codes of the materials.

15. The material requirement planning method as claimed in claim 14, further comprising the steps of:
determining whether a retrieved low-level code is a last low-level code; and
retrieving data on a material corresponding to a next low-level code and returning to step (a), if said retrieved low-level code is not a last low-level code.

16. A material requirement planning method comprising:
retrieving data on a material from a database based on requirement dates;
calculating on-hand and available inventories of said material;
calculating net requirements when an available inventory is zero or is not zero while is derived from other allocations; and
calculating net requirements when said available inventory is not zero and not derived form other allocations, by either re-scheduling routing if necessary and successively calculating net requirements, or directly calculating net requirements.
